(19) United States
(12) Patent Application Publication
(10) Pub. No.: US 2020/0019112 A1
(43) Pub. Date: Jan. 16, 2020

(54) IMAGE FORMING APPARATUS

(71) Applicant: CANON KABUSHIKI KAISHA, Tokyo (JP)

(72) Inventor: Tsubasa Ito, Toride-shi (JP)

(21) Appl. No.: 16/451,291

(22) Filed: Jun. 25, 2019

(30) Foreign Application Priority Data
Jul. 12, 2018 (JP) 2018-132718

(51) Int. Cl. G03G 21/16; G03G 15/00

(52) U.S. Cl. CPC G03G 21/1633; G03G 15/5016

(57) ABSTRACT

An image forming apparatus includes an apparatus body including an image forming unit, a transfer portion, a fixing portion, a sheet discharge portion configured to discharge the sheet on which the toner image has been fixed by the fixing portion, and a supporting surface on which the sheet discharged by the sheet discharge portion is supported, and a cover member supported on the apparatus body and arranged above the supporting surface so as to form a space between the supporting surface and the cover member, wherein the cover member includes a communicating portion configured to communicate the space with an exterior of the cover member, the communicating portion being arranged on an outside of the supporting surface in a width direction orthogonal to a sheet discharge direction and arranged above the supporting surface in a state the cover member is supported on the apparatus body.

### BACKGROUND OF THE INVENTION

### Field of the Invention

The present invention relates to an image forming apparatus for forming images on sheets.

### Description of the Related Art

Hitherto, a printer has been proposed that forms an image on a sheet and discharge the sheet onto which image has been formed via a sheet discharge roller to a sheet discharge tray (refer to Japanese Patent Application Laid-Open Publication No. 2000-280570). In the printer, a cover is provided above the sheet discharge tray, and a top face of the cover has a plane surface shape to allow various devices to be placed thereon.

The printer disclosed in Japanese Patent Application Laid-Open Publication No. 2000-280570 includes an image forming engine adopting an electrophotographic system, and toner image transferred to the sheet by a transfer roller is subjected to heat and pressure in a fixing unit and thereby fixed to the sheet. In such fixing process, moisture contained in the sheet turns into vapor and is discharged through the sheet discharge port together with the sheet. The vapor discharged through the sheet discharge port may adhere to a lower surface of the cover as droplets, which may cause a drawback of deterioration of quality of a subsequent sheet by adsorbing the droplets.

### SUMMARY OF THE INVENTION

According to one aspect of the present invention, an image forming apparatus includes an apparatus body including an image forming unit configured to form a toner image on an image bearing member, a transfer portion configured to transfer the toner image on the image bearing member to a sheet, a fixing portion configured to fix the toner image to the sheet, a sheet discharge portion arranged above the fixing portion and configured to discharge the sheet on which the toner image has been fixed by the fixing portion, and a supporting surface on which the sheet discharged by the sheet discharge portion is supported, and a cover member supported on the apparatus body and arranged above the supporting surface so as to form a space between the supporting surface and the cover member, wherein the cover member includes a communicating portion configured to communicate the space with an exterior of the cover member, the communicating portion being arranged on an outside of the supporting surface in a width direction orthogonal to a sheet discharge direction and arranged above the supporting surface in a state the cover member is supported on the apparatus body.

Further features of the present invention will become apparent from the following description of exemplary embodiments with reference to the attached drawings.

### BRIEF DESCRIPTION OF THE DRAWINGS

FIG. 1 is an overall schematic diagram illustrating a printer according to a first embodiment.

FIG. 2 is a cross-sectional view illustrating the printer.

FIG. 3A is a side view illustrating the printer.

FIG. 3B is a 3B-3B arrow view of FIG. 3A.

FIG. 3C is an enlarged view illustrating a dashed line portion of FIG. 3B.

FIG. 4 is an exploded perspective view illustrating a printer.

FIG. 5 is a perspective view illustrating the printer from a side.

FIG. 6 is a perspective view illustrating the printer from the side and upper direction.

FIG. 7 is a plan view illustrating the printer.

FIG. 8 is a front view illustrating the printer.

FIG. 9 is a perspective rear view illustrating the printer.

FIG. 10A is a side view illustrating a state where a cover member is removed from an apparatus body.

FIG. 10B is a side view illustrating a state where the cover member is attached to the apparatus body.

FIG. 11 is a perspective bottom view illustrating the cover member.

FIG. 12 is a cross-sectional view illustrating the flow of vapor.

FIG. 13 is a perspective view illustrating a printer according to a second embodiment.

### DESCRIPTION OF THE EMBODIMENTS

### First Embodiment

### General Configuration

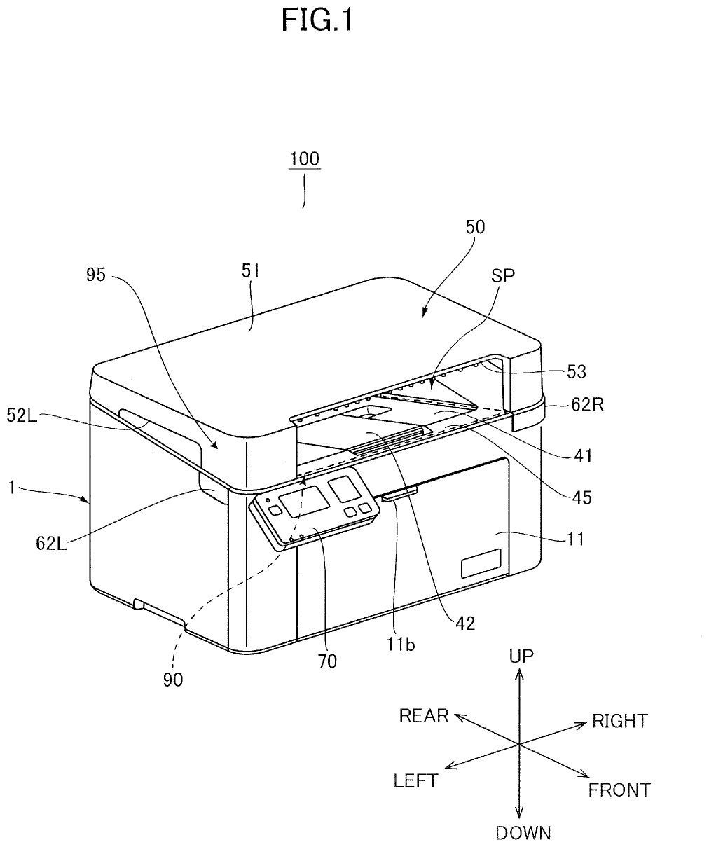

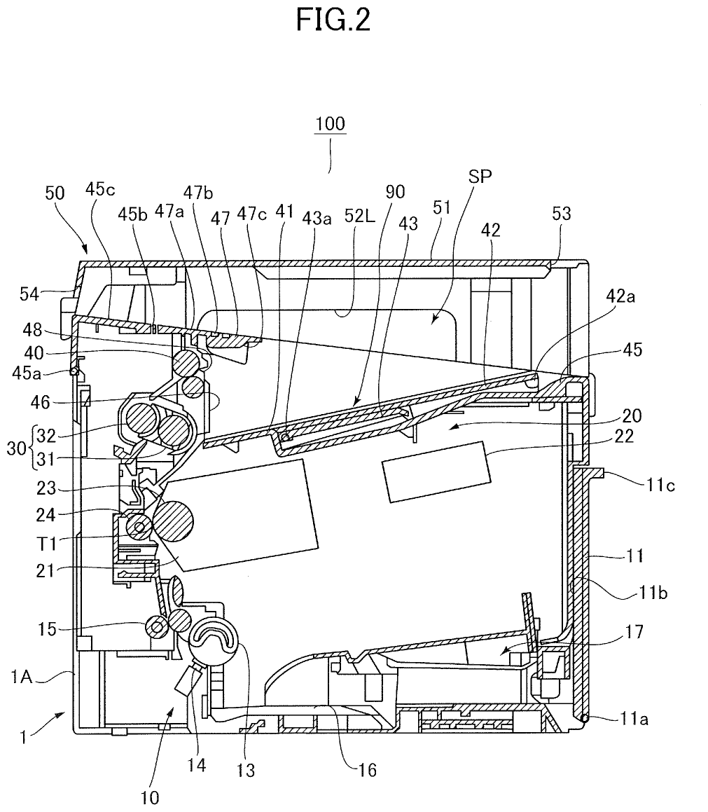

A printer 100 serving as an image forming apparatus according to a first embodiment is a laser beam printer adopting an electrophotographic system that forms a monochrome toner image. The printer 100 includes, as illustrated in FIGS. 1 and 2, an apparatus body 1, a cover member 50, and a display device 70 that displays various information of the printer 100. The cover member 50 is detachably supported on the apparatus body 1 and arranged above a supporting surface 90 so as to form a space SP between the supporting surface 90 of the apparatus body 1. The apparatus body 1 includes a sheet feeding apparatus 10 configured to feed a sheet, an image forming unit 20 forming an image on the sheet being fed, and a sheet discharge roller pair 40 for of discharging the sheet onto the supporting surface 90.

In a state where an image forming command is output to the printer 100, an image forming process by the image forming unit 20 is started based on image information entered from an external computer and the like connected to the printer 100. The image forming unit 20 includes a process cartridge 21, a laser scanner 22, a transfer roller 24, and a fixing portion 30. The process cartridge 21 includes a rotatable photosensitive drum 23, and a charge roller, a developing roller and a cleaning blade not shown arranged along the photosensitive drum 23. The transfer roller 24 forms a transfer nip T1 serving as a transfer portion together with the photosensitive drum 23 serving as an image bearing member. The process cartridge 21 can be attached to and detached from the apparatus body 1 of the printer 100. In the present embodiment, the printer 100 is a monochrome laser beam printer, but the invention is not limited to this example. For example, the printer 100 can be a full color laser beam printer, and in that case, the intermediate transfer belt serves as an image bearing member that bears the toner image.

The laser scanner 22 serving as an image forming unit irradiates laser beams to the photosensitive drum 23 based on the entered image information. In this state, the photosensitive drum 23 is charged in advance by a charge roller, and an electrostatic latent image is formed on the photosensitive drum 23 by laser beams irradiated thereto. Thereafter, the electrostatic latent image is developed by the developing roller, and a monochrome toner image is formed on the photosensitive drum 23.

Simultaneously as the above-described image forming process, the sheet is fed from the sheet feeding apparatus 10. The sheet feeding apparatus 10 includes a first tray 11 supported to open and close with respect to the apparatus body 1 around a shaft 11a. The first tray 11 constitutes a part of an exterior portion of a front face of the apparatus body 1 in a closed state, and in a state where the first tray 11 is opened, the user can access a sheet storage space 17 inside the apparatus body 1.

The first tray 11 includes a loading surface 11b on which sheets are placed. In order to set sheets to the sheet storage space 17, the user opens the first tray 11 and places sheets on the loading surface 11b. A knob portion 11c that the user operates to open the first tray 11 is provide on the first tray 11, and the user can easily open the first tray 11 using the knob portion 11c.

Furthermore, the sheet feeding apparatus 10 includes a sheet supporting portion 16 that supports an upstream side in a sheet conveyance direction of the sheet placed on the loading surface 11b of the first tray 11, a pickup roller 13, and a separation pad 14. In response to the image forming command, the sheet supporting portion 16 rises and the sheet supported on the sheet supporting portion 16 contacts the pickup roller 13. When the pickup roller 13 rotates in this state, the sheet is fed while being separated one by one by the separation pad 14.

The sheet separated one by one by the separation pad 14 is conveyed to a registration roller pair 15 and skewing of the sheet is corrected by the registration roller pair 15. The sheet conveyed at a predetermined conveyance timing by the registration roller pair 15 is subjected to electrostatic load bias applied to the transfer roller 24, and toner image on the photosensitive drum 23 is transferred at the transfer nip T1. The toner remaining on the photosensitive drum 23 is collected by a cleaning blade.

Predetermined heat and pressure is applied from a heating roller 31 and a pressure roller 32 of the fixing portion 30 to the sheet on which the toner image has been transferred, by which the toner is melted and fixed. The sheet that has passed through the fixing portion 30 is discharged onto the supporting surface 90 by the sheet discharge roller pair 40 serving as a sheet discharge portion. The sheet discharge roller pair 40 is arranged above the fixing portion 30.

### Apparatus Body

Next, the apparatus body 1 will be described in further detail. The apparatus body 1 includes, as illustrated in FIG. 2, an abutment surface 46 that is arranged upstream of the supporting surface 90 in the sheet discharge direction and extending in the vertical direction. The sheet discharged onto the supporting surface 90 slides toward the abutment surface 46 since the supporting surface 90 is inclined downward toward the abutment surface 46, and the sheets are aligned with their trailing edges abutting against the abutment surface 46. A sheet discharge port 48 through which the sheet is discharged by the sheet discharge roller pair 40 is formed on the abutment surface 46.

As illustrated in FIGS. 2, 3B, 3C and 4, a guide member 47 is pivotably supported downstream of the sheet discharge port 48 in the sheet discharge direction. A lower surface 47c of the guide member 47 abuts against an upper surface of the sheet passing through the sheet discharge port 48 and guides the sheet toward the supporting surface 90. The lower surface 47c has a curved surface that is protruded upward, and the curved surface functions to correct curling of the sheet as the sheet is guided along the curved surface. Further, the guide member 47 includes a plurality of holes 47b that are aligned along a width direction orthogonal to the sheet discharge direction, and the plurality of holes 47b are respectively passed through the guide member 47 in the vertical direction.

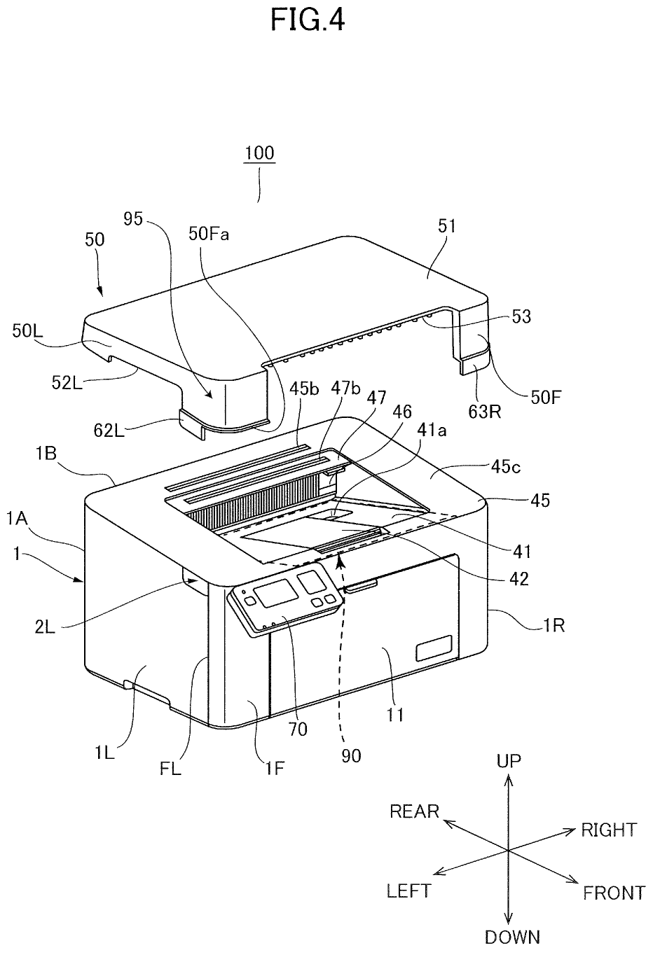

In the following description, up and down, right and left and front and rear directions are defined based on a state in which the display device 70 illustrated in FIG. 1 is viewed from the front side. As illustrated in FIG. 4, the apparatus body 1 includes a frame member 1A that constitutes an exterior portion of the apparatus body 1 other than the upper portion thereof, and an upper cover 45 that is supported in an openable and closable manner with respect to the frame member 1A. The frame member 1A includes a front panel 1F, a left side panel 1L, a right side panel 1R and a rear panel 1B. The display device 70 is attached to a left side, i.e., first side, of the front panel 1F in the width direction. A liquid crystal panel and a plurality of buttons are provided on the display device 70, which are used to display various information or to enter an image forming job. A concave portion 2L into which a user can insert his/her fingers and the like is formed at a corner portion between the upper cover 45 of the left side panel 1L and the front panel 1F. The concave portion 2L serving as the first concave portion is formed in a recessed shape that is recessed toward an inner side of the apparatus body 1 than the other face of the left side panel 1L.

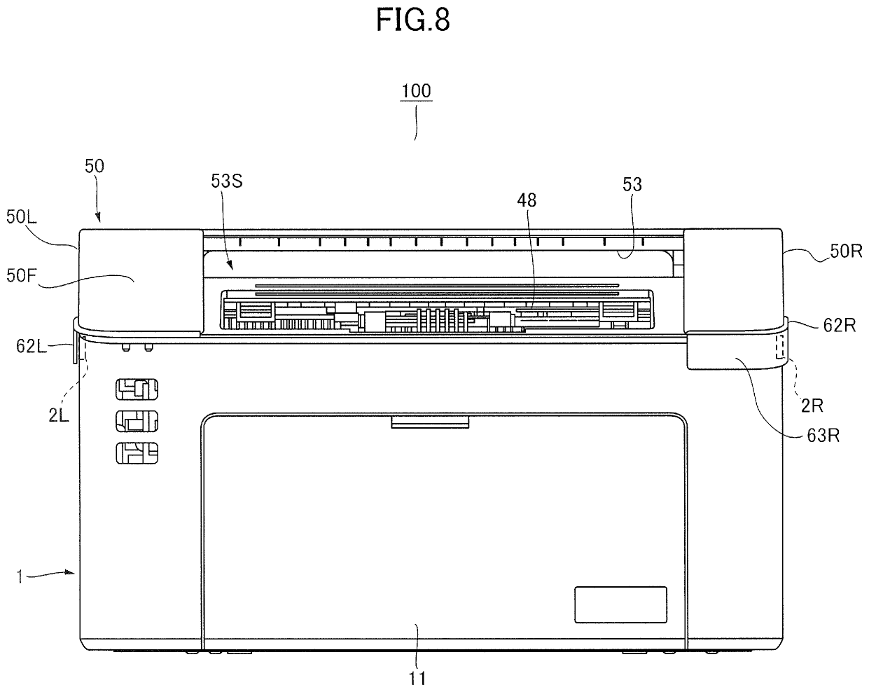

Since the upper area of the concave portion 2L is formed to open, the user can insert his/her fingers to the concave portion 2L to hold the upper cover 45 positioned above the concave portion 2L and open the upper cover 45. Further, since a first end edge of the concave portion 2L is formed along a boundary portion FL between the front panel 1F and the left side panel 1L, it has a high design property. Similarly, a concave portion 2R serving as a second concave portion having a same shape as the concave portion 2L is formed on the right side panel 1R (refer to FIG. 8).

As illustrated in FIG. 4, the upper cover 45 is supported to open and close with respect to the frame member 1A around the shaft 45a (refer to FIG. 2) extending in the width direction, and in a closed state, the upper cover 45 constitutes an exterior portion of an upper side of the apparatus body 1 in a closed state. Moreover, in an opened state, the upper cover 45 exposes an inside of the apparatus body 1 to enable replacement the process cartridge 21 arranged on the inside of the apparatus body 1 or removal of jammed sheets. The upper cover 45 includes an upper surface 45c that is inclined downward toward the front direction, and a sheet discharge tray 41 inclined downward to the rear direction toward the abutment surface 46.

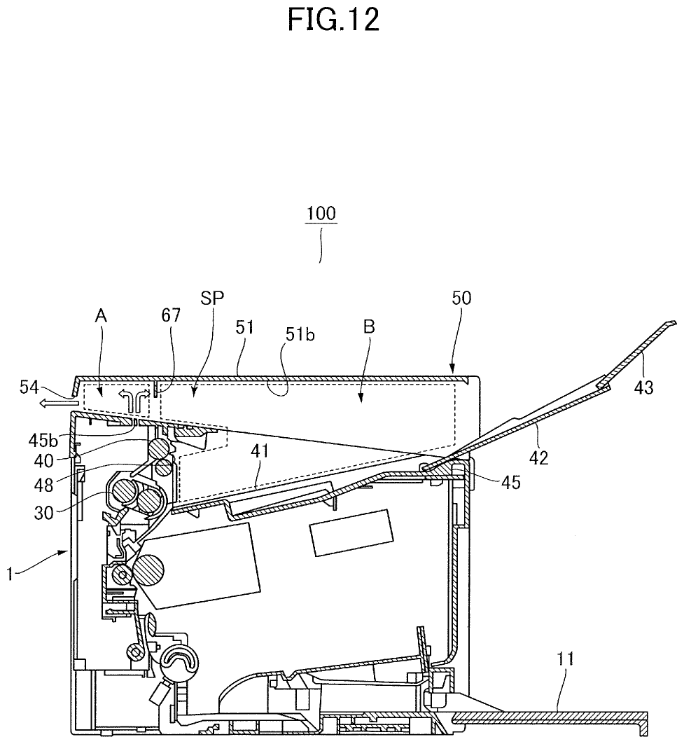

An extension tray 42 is pivotably supported around a pivot shaft 42a (refer to FIG. 2) on the sheet discharge tray 41, and an auxiliary tray 43 is further pivotably supported around a pivot shaft 43a on the extension tray 42. By opening the extension tray 42 and the auxiliary tray 43, as illustrated in FIG. 12, in a case where the sheet to be discharged to the exterior of the sheet discharge roller pair 40 is a sheet that has a long length in the sheet discharge direction, the sheet can be received by and loaded on the tray. A recess portion 41a arranged adjacent to the extension tray 42 is formed on the sheet discharge tray 41, and the user can easily open the extension tray 42 by inserting his/her fingers in the recess portion 41a.

The supporting surface 90 is an area capable of supporting the sheet discharged to the exterior of the sheet discharge roller pair 40 (refer to FIG. 2), which is illustrated by the dashed line in FIG. 4. That is, the supporting surface 90 is composed of the sheet discharge tray 41, an upper surface of the extension tray 42 and a part of the upper surface 45c. In a state where the extension tray 42 and the auxiliary tray 43 are opened, the upper surfaces of the extension tray 42 and the auxiliary tray 43 in the opened state constitute a part of the supporting surface 90.

A vapor outlet 45b arranged above the fixing portion 30 for allowing vapor generated by the sheet being heated while passing through the fixing portion 30 to escape into the space SP is formed on the upper surface 45c of the upper cover 45, as illustrated in FIGS. 2 and 4. The vapor outlet 45b is a hole that passes the upper cover 45 in the vertical direction, and it is formed to have a long length in the width direction in approximately the same width as the holes 47b of the guide member 47 and roller widths of the heating roller 31 and the pressure roller 32 of the fixing portion 30. As described, vapor generated in the fixing portion 30 is mainly discharged through the vapor outlet 45b and the sheet discharge port 48 to the space SP. Since a portion of the vapor that has been discharged through the sheet discharge port 48 passes through the holes 47b of the guide member 47 and elevates, vapor is prevented from being condensed on a lower surface 47c of the guide member 47 and adhered thereon as droplets.

### Cover Member

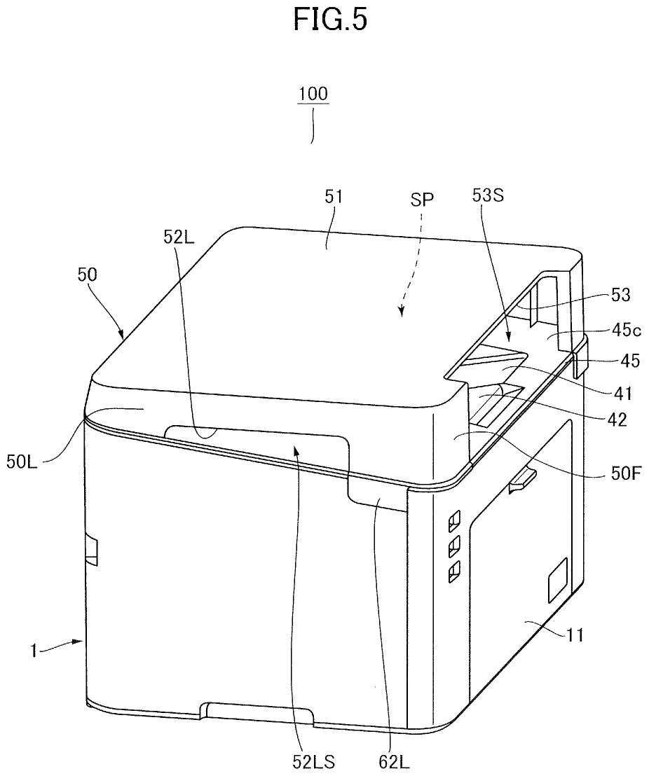

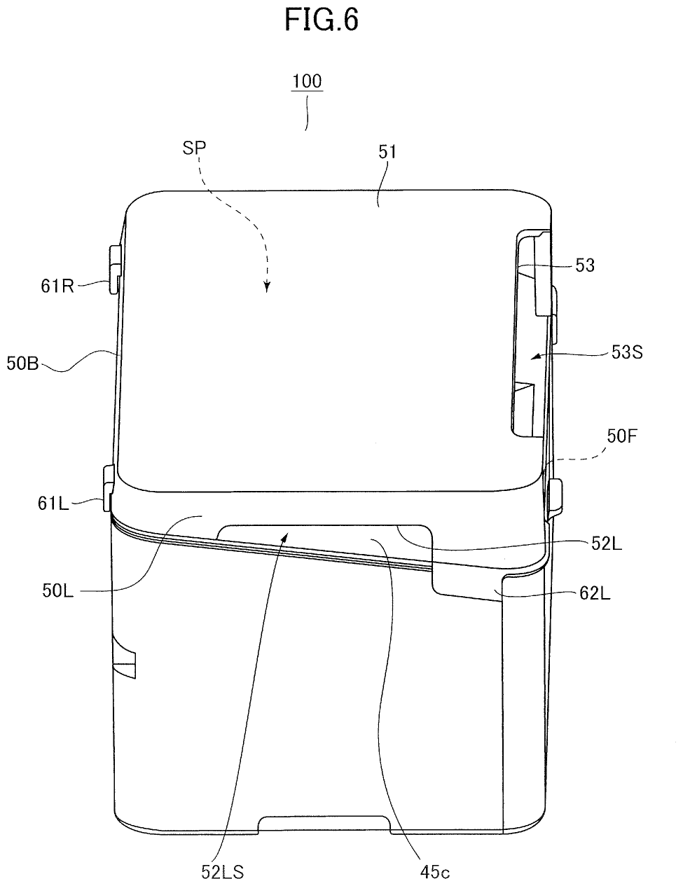

Next, the cover member 50 will be described in further detail. FIG. 4 is an exploded perspective view illustrating the apparatus body 1 and the cover member 50, and FIGS. 5 through 9 are external views illustrating a state in which the cover member 50 is attached to the apparatus body 1. The cover member 50 includes, as illustrated in FIGS. 4 through 9, a front wall 50F, a left side wall 50L, a right side wall 50R, a rear wall 50B, and a top panel 51. The top panel 51 is a plane surface that extends in the horizontal direction and configured to allow users to place sheets and the like thereon. The left side wall 50L and the right side wall 50R are arranged on both end sides in the width direction of the cover member 50. The front wall 50F is disposed on the downstream side in the sheet discharge direction of the cover member 50. The rear wall 50B is disposed on the upstream side in the sheet discharge direction of the cover member 50.

A notch portion 52L that is notched upward than the upper surface 45c of the upper cover 45 constituting the upper surface of the apparatus body 1 is formed on the left side wall SOL when viewed in a width direction, i.e., right-left direction from the outside of the apparatus body 1, as illustrated in FIGS. 5, 6 and 10B. That is, the notch portion 52L is positioned upward than the supporting surface 90. The notch portion 52L serving as a communicating portion and a first communicating portion forms a communication space 52LS between the upper surface 45c of the upper cover 45, and the communication space 52LS allows the space SP formed between the apparatus body 1 and the cover member 50 to communicate with the exterior of the cover member 50.

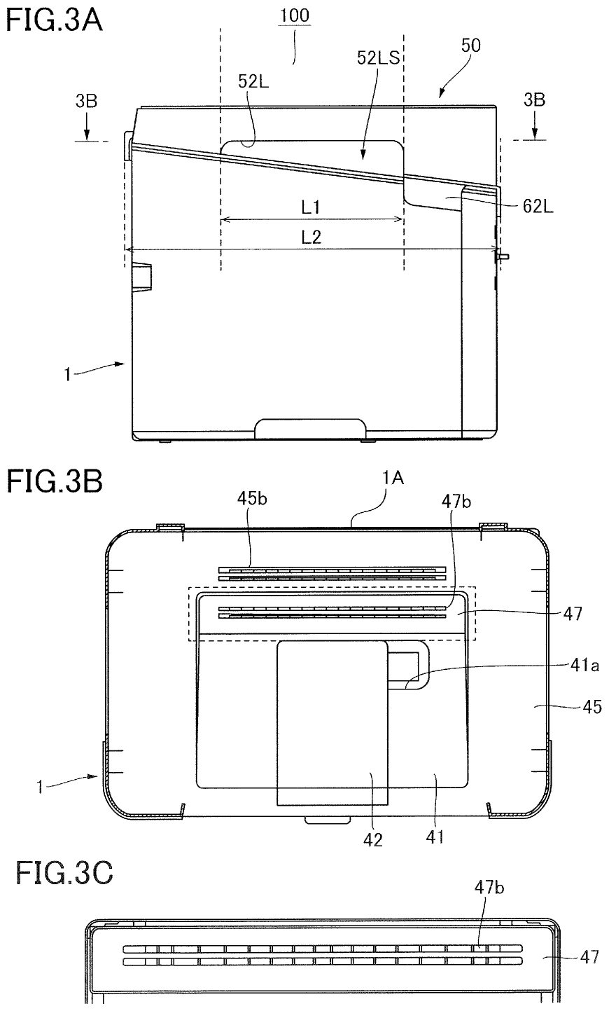

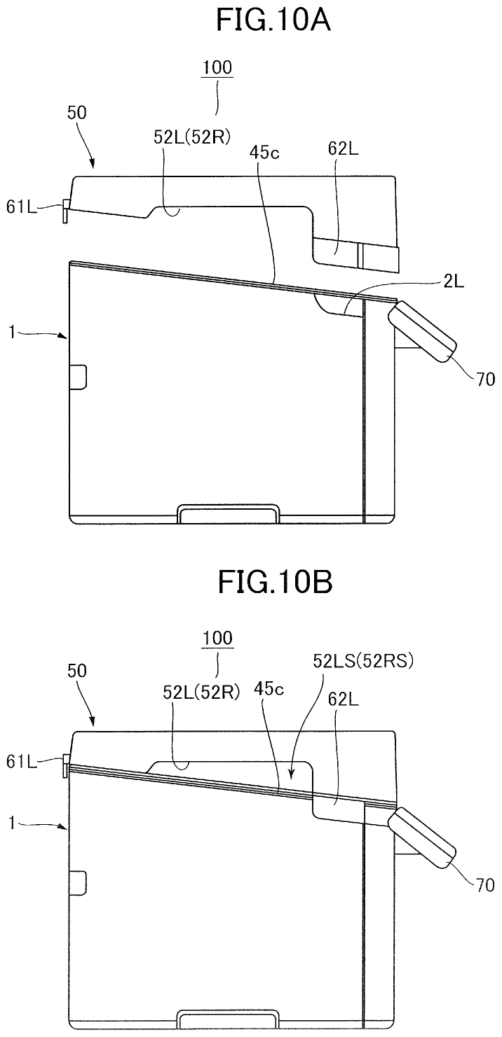

The notch portion 52L has, as illustrated in FIG. 3A, a length L1 that is one-third of an overall length L2 of the cover member 50 or greater in the front-rear direction. Of course, the length L1 in the front-rear direction of the notch portion 52L is equal to or smaller than the length L2 of the cover member 50. A notch portion 52R having a same shape as the notch portion 52L on the left side wall 50L is formed on the right side wall 50R, and the notch portion 52R serving as a communicating portion and a first communicating portion forms a communication space 52RS between the upper surface 45c of the upper cover 45 (refer to FIG. 10B).

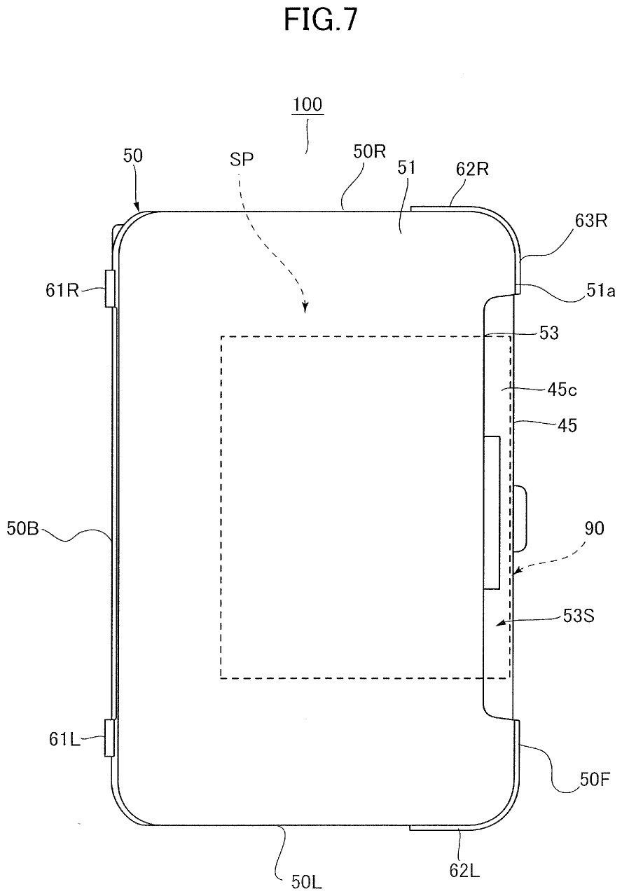

As illustrated in FIG. 7, a notch part 53 that exposes at least a part of the supporting surface 90 in a state where the cover member 50 is supported on the apparatus body 1 is formed on a front side of the cover member 50 in a plan view taken from above the cover member 50. The notch part 53 is formed to extend from a lower end 50Fa (refer to FIG. 4) of the front wall 50F to a part of the top panel 51, and it is notched more upstream than a downstream edge 51a of the top panel 51 in the sheet discharge direction. The notch part 53 forms a communication space 53S between the supporting surface 90, and the communication space 53S allows the space SP formed between the apparatus body 1 and the cover member 50 to communicate with the exterior of the cover member 50. The communication space 53S is an outlet through which the sheet supported on the supporting surface 90 can be removed. The notch part 53 is formed longer than the supporting surface 90 in the width direction. The notch portion 52L and the notch part 53 of the cover member 50 are formed mutually separately, and a supporting portion 95 (refer to FIGS. 1 and 4) supported on the apparatus body 1 is formed between the notch portion 52L and the notch part 53.

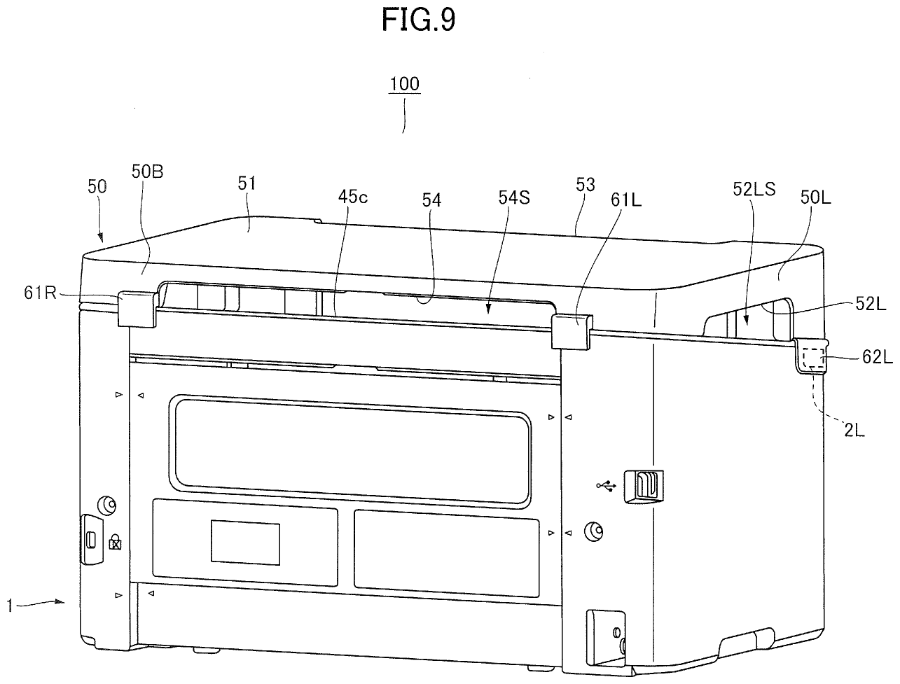

As illustrated in FIG. 9, a notch portion 54 that is notched upward than the upper surface 45c of the upper cover 45 constituting the upper surface of the apparatus body 1 is formed on the rear wall 50B of the cover member 50. The notch portion 54 serving as the second communicating portion forms a communication space 54S between the upper surface 45c of the upper cover 45, and the communication space 54S allows the space SP formed between the apparatus body 1 and the cover member 50 to communicate with the exterior of the cover member 50.

As illustrated in FIGS. 4 through 9, a cover portion 62L is extended downward from the left side wall 50L serving as a first side surface of the cover member 50. The cover portion 62L serving as a first cover portion is formed in an approximately rectangular shape along the shape of the concave portion 2L but formed slightly greater than the concave portion 2L. The cover portion 62L is formed to cover the concave portion 2L in a state where the cover member 50 is supported on the apparatus body 1, as illustrated in FIGS. 10A and 10B. Further, a cover portion 62R (refer to FIG. 8) serving as the second cover portion is formed on the right side wall 50R serving as a second side surface of the cover member 50 so as to cover the concave portion 2R. Thus, in a state where the cover member 50 is supported on the apparatus body 1, the user cannot access the concave portions 2L and 2R due to the cover portions 62L and 62R, so opening of the upper cover 45 can be regulated. Further, the cover portions 62L and 62R are respectively formed continuously from the notch portions 52L and 52R, such that unevenness of the cover member 50 is minimized and the design and workability are improved.

As illustrated in FIGS. 7 through 9, the cover member 50 includes a first positioning portion 61L, a second positioning portion 61R and a third positioning portion 63R that positions the cover member 50 with respect to the apparatus body 1. The first positioning portion 61L and the second positioning portion 61R are formed to extend downward from the rear wall 50B of the cover member 50. The first positioning portion 61L is arranged upstream of the apparatus body 1 in the sheet discharge direction and on a first side of the apparatus body 1 in the width direction, and at least a portion of the first positioning portion 61L is disposed to overlap with the apparatus body 1 in the up-down direction. The second positioning portion 61R is arranged upstream of the apparatus body 1 in the sheet discharge direction and on a second side of the apparatus body 1 in the width direction, and at least a portion of the second positioning portion 61R in the up-down direction is disposed to overlap with the apparatus body 1.

The third positioning portion 63R is formed to extend downward from the front wall 50F of the cover member 50 and formed integrally with the cover portion 62R. That is, the cover portion 62R and the third positioning portion 63R are formed integrally and curved smoothly to cover a corner portion on a front right side of the apparatus body 1. Thereby, manufacturing cost of the cover member 50 can be cut down and design can be improved. The third positioning portion 63R is arranged downstream of the apparatus body 1 in the sheet discharge direction and on a second side of the apparatus body 1 in the width direction. The display device 70 is arranged at a position symmetrical to the third positioning portion 63R with respect to the center of the cover member 50 in the width direction, such that a positioning portion is not formed on the cover portion 62L side.

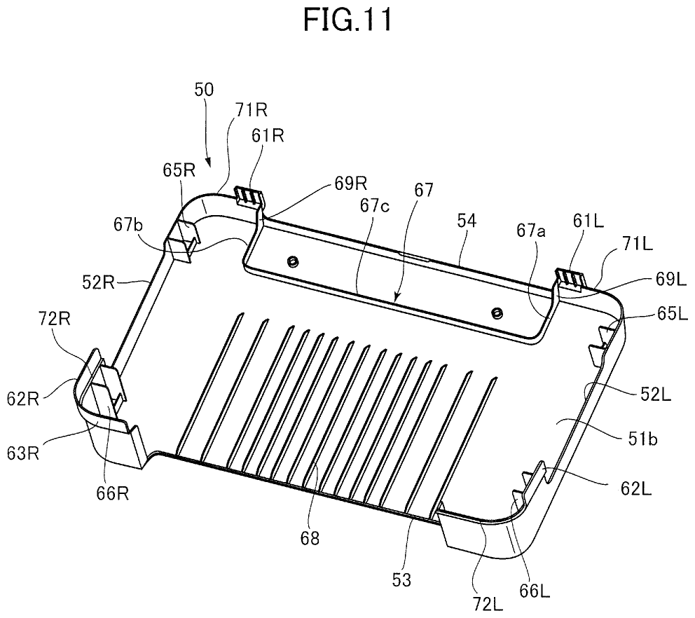

As illustrated in FIG. 11, abutment surfaces 71L, 71R, 72L and 72R are formed at positions corresponding to four corner portions of the cover member 50. In a state where the abutment surfaces 71L, 71R, 72L and 72R are abutted against the upper surface 45c of the upper cover 45 of the apparatus body 1, the cover member 50 is supported on the apparatus body 1. Further, the first positioning portion 61L, the second positioning portion 61R and the cover portion 62L are respectively arranged on the outer side of the apparatus body 1 than the abutment surfaces 71L, 71R and 72L. Therefore, the first positioning portion 61L, the second positioning portion 61R and the cover portion 62L form stepped shapes with the abutment surfaces 71L, 71R and 72L.

Further, the cover portion 62R and the third positioning portion 63R are arranged on an outer side of the apparatus body 1 than the abutment surface 72R. Therefore, the cover portion 62R, the third positioning portion 63R and the abutment surface 72R form a stepped shape. The stepped shapes formed on the four corners of the cover member 50 allow the cover member 50 to be supported stably on the apparatus body 1.

As illustrated in FIG. 11, reinforcing ribs 65L, 65R, 66L, 66R, 69L and 69R are formed on a lower surface 51b of the cover member 50. The reinforcing ribs 65L and 66L are arranged to sandwich the notch portion 52L in the front-rear direction, and the reinforcing ribs 65R and 66R are arranged to sandwich the notch portion 52R in the front-rear direction. Further, the reinforcing ribs 69L and 69R are arranged to sandwich the notch portion 52L in the right-left direction. The reinforcing ribs 65L, 65R, 66L, 66R, 69L and 69R enhance the strength of cover member 50, especially the strength of the cover member 50 against load from the top panel 51.

Further, a plurality of guide ribs 68 extending in the sheet discharge direction are formed on a lower surface 51b of the cover member 50. The guide ribs 68 reduce contact area between the sheet discharged by the sheet discharge roller pair 40 (refer to FIG. 2) and the cover member 50 to thereby reduce conveyance resistance acting on the sheet. Thereby, folding or curling of the sheet can be reduced.

Further, a wall portion 67 that extends downward from the lower surface 51b is formed on the cover member 50. The wall portion 67 includes a first rib 67a formed integrally with the reinforcing rib 69L and extending downstream in the sheet discharge direction from the reinforcing rib 69L, and a second rib 67b formed integrally with the reinforcing rib 69R and extending downstream in the sheet discharge direction from the reinforcing rib 69R. Further, the wall portion 67 includes a third rib 67c that extends in the width direction, i.e., right-left direction, connecting the first rib 67a and the second rib 67b. The wall portion 67 has a substantially rectangular shape with one side opened formed by the first rib 67a, the second rib 67b and the third rib 67c, and it is arranged so as to surround the vapor outlet 45b formed on the upper cover 45. The vapor outlet 45b and the sheet discharge port 48 is arranged at mutually different positions in the sheet discharge direction, and the third rib 67c serving as the projected portion is arranged between the vapor outlet 45b and the sheet discharge port 48 in the sheet discharge direction.

As described, according to the present embodiment, notch portions 52L, 52R, 53 and 54 are respectively formed on the left side wall 50L, the right side wall 50R, the top panel 51 and the rear wall 50B of the cover member 50. Thereby, the vapor that has been generated in the fixing portion 30 and discharge through the vapor outlet 45b or the sheet discharge port 48 into the space SP passes through the communication spaces 52 LS, 52RS, 53S and 54S formed by the notch portions 52L, 52R, 53 and 54 and released to the exterior of the cover member 50. Thus, the amount of vapor in the space SP is reduced, so that vapor can be prevented from being adhered as droplets to the lower surface 51b of the cover member 50, for example. Thus, the probability of sheets being discharged absorbing droplets can be reduced, and sheet quality can be improved.

According further to the present embodiment, the wall portion 67 is formed on the lower side of the cover member 50. As illustrated in FIG. 12, the wall portion 67 divides the space SP into a first space A positioned above the vapor outlet 45b and a second space B positioned above the sheet discharge port 48. Therefore, the vapor passing through the vapor outlet 45b and rising is discharged into the first space A but is regulated from moving from the first space A to the second space B by the wall portion 67. As described, the vapor discharged through the vapor outlet 45b is guided to be released to the exterior of the cover member 50 through the notch portion 54 without moving into the second space B, so that the amount of vapor in the second space B is reduced. Thereby, the generation of droplets in the second space B can be suppressed.

Since the third rib 67c of the wall portion 67 is arranged upstream in the sheet discharge direction than the sheet discharge port 48, the sheet discharged through the sheet discharge port 48 will not contact the lower surface 51b of the cover member 50 on the upstream side in the sheet discharge direction than the third rib 67c. In other words, the sheet passes the second space B side in which generation of droplets are suppressed, such that the absorption of droplets on sheets can be reduced, and the sheet quality can be improved. The vapor discharged through the sheet discharge port 48 is discharged to the second space B, and further passes through the communication spaces 52LS, 52RS and 53S formed by the notch portions 52L, 52R and 53 to be released to the exterior of the cover member 50.

The notch portions 52L, 52R, 53 and 54 are formed to have a relatively wide width, and reinforcing ribs 65L, 65R, 66L, 66R, 69L and 69R are respectively disposed to sandwich the notch portions 52L, 52R, 53 and 54. Thereby, the strength of the cover member 50 can be ensured sufficiently, and the wide width of the notch portions 52L, 52R, 53 and 54 allow vapor to be released easily to the exterior of the cover member 50.

The top panel 51 of the cover member 50 is composed of a plane surface that extends in the horizontal direction and configured to allow users to place sheets and the like thereon. Further, the top panel 51 of the cover member 50 functions to reduce the amount of dust adhering to the sheets supported on the supporting surface 90, and to cover the printed image on the sheet to prevent other users from seeing the image from the viewpoint of security. As described, according to the present embodiment, it is not only possible to use the space above the apparatus body 1 effectively, but since notch portions 52L, 52R, 53 and 54 are formed on the cover member 50, it is also possible to suppress the amount of vapor remaining in the space SP and prevent deterioration of sheet quality caused by adhesion of droplets.

Since the notch part 53 is formed to expose at least a part of the supporting surface 90 in a plan view from the upper portion of the cover member 50, the visibility of the sheets supported on the supporting surface 90 is improved and the operability to remove sheets is also improved. Especially, the notch part 53 is formed longer than the supporting surface 90 in the width direction, the visibility and operability of the sheets are further improved. Thereby, the user can easily determine whether a sheet is supported on the supporting surface 90 or what type of sheet is supported on the supporting surface 90. The shapes and lengths of the notch portions 52L,52R, 53 and 54 are not limited to those disclosed in the present embodiment, but they can be determined arbitrarily considering the strength and design of the cover member 50 and loadability of sheets on the top panel 51.

For example, in order to replace the process cartridge 21, the user first removes the cover member 50 from the apparatus body 1 before inserting his/her fingers in the concave portions 2L and 2R to open the upper cover 45. However, some users may try to open the upper cover 45 while the cover member 50 is still supported on the apparatus body 1. In that case, in a state where the upper cover 45 has been opened to a predetermined angle, the cover member 50 may drop off from the upper cover 45 and the cover member 50 may be damaged. According to the present embodiment, the concave portions 2L and 2R used for opening the upper cover 45 is covered by the cover portions 62L and 62R, so that the user cannot access the concave portions 2L and 2R, and opening of the upper cover 45 can be regulated. The user is encouraged to open the upper cover 45 after removing the cover member 50, and the cover member 50 can be prevented from being damaged.

Further, the first positioning portion 61L, the second positioning portion 61R and the third positioning portion 63R are provided to the cover member 50. Since the first positioning portion 61L, the second positioning portion 61R and the third positioning portion 63R are hooked to the upper cover 45, even if the upper cover 45 is opened in a state where the cover member 50 is supported on the apparatus body 1, the cover member 50 will not be disengaged immediately. Therefore, even if the user attempts to open the upper cover 45 by an erroneous operation procedure, the cover member 50 can be prevented from being damaged.

In the present embodiment, notch portions 52L and 52R are formed respectively to the left and right side surfaces 50L and 50R of the cover member 50, but the notch portion may be formed on only either one of the left and right side surfaces 50L and 50R. Similarly, only either one of the concave portions 2L and 2R or only one of the cover portions 62L and 62R may be provided with the other one omitted.

### Second Embodiment

Next, a second embodiment of the present invention will be described, wherein in the second embodiment, hole portions 152L and 152R are formed to a cover member 150 instead of the notch portions 52L and 52R according to the first embodiment. Therefore, configurations similar to the first embodiment are either not shown or denoted with the same reference numbers in the drawing.

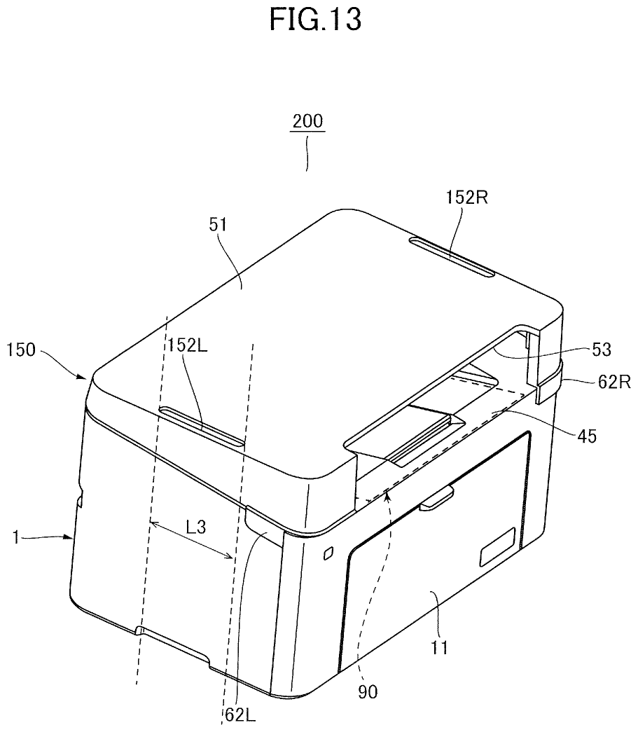

A printer 200 serving as an image forming apparatus according to a second embodiment includes, as illustrated in FIG. 13, the cover member 150. Hole portions 152L and 152R are formed on the top panel 51 of the cover member 150. Through holes having long hole shapes that extend in a sheet discharge direction are formed on the hole portions 152L and 152R serving as communicating portions, and they are positioned on an outer side of the supporting surface 90 in the width direction. The hole portions 152L and 152R have a length L3 that is one-third the overall length L2 (refer to FIG. 3A) of the cover member 150 or greater in the front-rear direction. Of course, the length L3 of the hole portions 152L and 152R in the front-rear direction is equal to or smaller than a length L2 of the cover member 150.

In the present embodiment, the hole portions 152L and 152R are formed on the top panel 51 of the cover member 150, so that the flow of vapor rising by heat is not blocked, and vapor can be released more efficiently to the exterior of the cover member 150. The cover member 150 is formed of a resin material, for example, and it is formed by injection molding. In that case, it may be possible to form a mold inexpensively by creating holes portions 152L and 152R serving as through holes compared to creating a notch portion as described in the first embodiment. Moreover, hole portions for releasing vapor can be formed on the left and right side surfaces 50L and 50R of the cover member, or a notch portion for releasing vapor can be formed on the top panel 51 of the cover member.

In the embodiments described above, the notch portion 54 is formed on the rear wall 50B of the cover member, but the present invention is not limited thereto. For example, the notch portion 54 can be replaced with a through hole, or the notch portion 54 can be omitted. In the embodiments described above, the wall portion 67 is disposed on the lower surface 51b of the cover member, but the wall portion 67 can be omitted. Further, the vapor outlet 45b can be omitted.

Further according to the embodiments described above, printer 100 or 200 adopting the electrophotographic system is described, but the present invention is not limited to these examples. For example, the present invention can be applied to an inkjet-type image forming apparatus for forming an image on a sheet by discharging ink through nozzles.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No.2018-132718, filed Jul. 12, 2018, which is hereby incorporated by reference herein in its entirety.

What is claimed is:

1. An image forming apparatus comprising:
an apparatus body comprising an image forming unit configured to form a toner image on an image bearing member, a transfer portion configured to transfer the toner image on the image bearing member to a sheet, a fixing portion configured to fix the toner image to the sheet, a sheet discharge portion arranged above the fixing portion and configured to discharge the sheet on which the toner image has been fixed by the fixing portion, and a supporting surface on which the sheet discharged by the sheet discharge portion is supported; and
a cover member supported on the apparatus body and arranged above the supporting surface so as to form a space between the supporting surface and the cover member,
wherein the cover member comprises a communicating portion configured to communicate the space with an exterior of the cover member, the communicating portion being arranged on an outside of the supporting surface in a width direction orthogonal to a sheet discharge direction and arranged above the supporting surface in a state the cover member is supported on the apparatus body.

2. The image forming apparatus according to claim 1, wherein the cover member comprises a notch part configured to form an outlet through which the sheet supported on the supporting surface is removed, and
the communicating portion and the notch part are formed separately from one another.

3. The image forming apparatus according to claim 2, wherein the cover member comprises a supporting portion supported on the apparatus body and configured to be arranged between the communicating portion and the notch part.

4. The image forming apparatus according to claim 1, wherein the communicating portion is a notch portion that is formed on a side wall of the cover member in the width direction and that is arranged above an upper surface of the apparatus body when viewed in the width direction.

5. The image forming apparatus according to claim 1, wherein the communicating portion is a hole portion that is formed on a side wall in the width direction or a top panel of the cover member.

6. The image forming apparatus according to claim 1, wherein the communicating portion has a length of one-third an overall length of the cover member or greater in a front-rear direction orthogonal to the width direction.

7. The image forming apparatus according to claim 1, wherein the communicating portion is a first communicating portion, and
the cover member comprises a second communicating portion arranged on a rear wall of the cover member and configured to communicate the space with an exterior of the cover member.

8. The image forming apparatus according to claim 1, wherein the apparatus body comprises a vapor outlet arranged above the fixing portion and configured to allow vapor generated at the fixing portion to escape to the space, and a sheet discharge port through which the sheet onto which the toner image has been fixed by the fixing portion and discharged to the supporting surface passes.

9. The image forming apparatus according to claim 8, wherein the vapor outlet and the sheet discharge port are arranged at mutually different positions in the sheet discharge direction, and
the cover member comprises a wall portion comprising a projected portion, the projected portion being configured to extend downward from a lower surface of a top panel of the cover member and arranged between the vapor outlet and the sheet discharge port in the sheet discharge direction.

10. The image forming apparatus according to claim 9, wherein the wall portion divides the space into a first space positioned above the vapor outlet and a second space positioned above the sheet discharge port.

11. The image forming apparatus according to claim 8, wherein the apparatus body comprises a guide member that is arranged downstream of the sheet discharge port in the sheet discharge direction and configured to guide the sheet toward the supporting surface by being in contact with an upper surface of the sheet passing the sheet discharge port, and
the guide member comprises a hole that passes through the guide member in a vertical direction.

12. The image forming apparatus according to claim 1, wherein a top panel of the cover member is a plane surface that extends in a horizontal direction.

13. The image forming apparatus according to claim 1, further comprising a display device arranged in a front side of the apparatus body in a front-rear direction and configured to display various information related to the image forming apparatus,
wherein the sheet discharge direction is a direction along the front-rear direction.

14. The image forming apparatus according to claim 1, wherein the apparatus body comprises an upper cover that includes the supporting surface and that exposes an inside of the apparatus body by being in an opened state, and a concave portion that is used to open the upper cover, and
the cover member comprises a cover portion configured to cover the concave portion.

15. The image forming apparatus according to claim 14, wherein the concave portion is a first concave portion that is provided on a first side of the apparatus body in a width direction orthogonal to a sheet discharge direction,
the cover portion is a first cover portion provided on the first side of the apparatus body in the width direction,
the apparatus body further comprises a second concave portion that is provided on a second side of the apparatus body in the width direction and that is used to open the upper cover, and
the cover member comprises a second cover portion that covers the second concave portion.

16. The image forming apparatus according to claim 15, further comprising a display device that is arranged on the first side of the apparatus body in the width direction and that displays various information related to the image forming apparatus,
wherein the upper cover is configured to open and close around a shaft that extends in the width direction,
the cover member comprises a first positioning portion, a second positioning portion and a third positioning portion that position the cover member with respect to the apparatus body,
the first positioning portion is arranged upstream of the apparatus body in the sheet discharge direction and arranged on the first side of the apparatus body in the width direction, and arranged such that at least a part of the first positioning portion is overlapped with the apparatus body in an up-down direction,
the second positioning portion is arranged upstream of the apparatus body in the sheet discharge direction and arranged on a second side of the apparatus body in the width direction, and arranged such that at least a part of the second positioning portion is overlapped with the apparatus body in the up-down direction, and
the third positioning portion is arranged downstream of the apparatus body in the sheet discharge direction and arranged on the second side of the apparatus body in the width direction, and arranged such that at least a part of the third positioning portion is overlapped with the apparatus body in the up-down direction.

17. The image forming apparatus according to claim 16, wherein the second cover portion is formed integrally with the third positioning portion.

18. The image forming apparatus according to claim 15, wherein the first cover portion is configured to extend downward from a first side wall in the width direction of the cover member, and
the second cover portion is configured to extend downward from a second side wall in the width direction of the cover member.

19. The image forming apparatus according to claim 1, wherein the cover member comprises a top panel, side walls disposed on both end sides in the width direction, a front wall provided on a downstream side in the sheet discharge direction, a rear wall provided on an upstream side in the sheet discharge direction, and a notch part formed to extend from a lower end of the front wall to a part of the top panel,
the notch part is formed longer than the supporting surface in the width direction, and
the notch part exposes at least a portion of the supporting surface in a plan view in a state where the cover member is supported on the apparatus body.

20. The image forming apparatus according to claim 19, wherein the notch part is notched more upstream than a downstream edge of the top panel in the sheet discharge direction.
